(19) United States
(12) Patent Application Publication
(10) Pub. No.: US 2013/0122225 A1
(43) Pub. Date: May 16, 2013

(54) ARTICLES AND METHODS PROVIDING SCALE-PHOBIC SURFACES

(71) Applicant: Massachusetts Institute of Technology, Cambridge, MA (US)

(72) Inventors: Gisele Azimi, Waltham, MA (US); Yuehua Cui, Lynn, MA (US); J. David Smith, Cambridge, MA (US); Kripa K. Varanasi, Lexington, MA (US)

(73) Assignee: MASSACHUSETTS INSTITUTE OF TECHNOLOGY, Cambridge, MA (US)

(21) Appl. No.: 13/679,729

(22) Filed: Nov. 16, 2012

Related U.S. Application Data
(60) Provisional application No. 61/560,469, filed on Nov. 16, 2011.

(51) Int. Cl. C09D 5/00; B05D 5/00

(52) U.S. Cl. CPC C09D 5/00; B05D 5/00
USPC 428/35.7; 428/34.1; 427/140

(57) ABSTRACT

This invention relates generally to articles, devices, and methods for inhibiting or preventing the formation of scale during various industrial processes. In certain embodiments, a vessel is provided for use in an industrial process, the vessel including a surface in contact with a mineral solution, wherein the surface is provided or is modified to have γ^{polar}/γ^{total} no greater than about 0.2 and/or the surface is provided or is modified to have a surface energy γ no greater than about 32 mJ/m², thereby providing resistance to mineral scale deposits thereupon.

### CROSS-REFERENCE TO RELATED APPLICATION

This application claims priority to and the benefit of, and incorporates herein by reference in its entirety, U.S. Provisional Patent Application No. 61/560,469, filed Nov. 16, 2011.

### FIELD OF THE INVENTION

This invention relates generally to inhibiting or preventing the formation of mineral scales on surfaces in industrial processes.

### BACKGROUND OF THE INVENTION

Scale formation is a persistent problem encountered in various industrial processes, which results in a significant reduction of the efficiency and lifetime of these processes. The challenges associated with scale formation have a major affect on the capital and operating costs of most conversion processes. For example, the costs associated with heat exchanger fouling for industrialized countries has been estimated to be about 0.25% of the gross national product (GNP) for these countries.

Among well-known mineral scale deposits, CaSO₄ is a mineral scale deposit encountered in many industrial processes. Besides having low solubility limits, a major difficulty with CaSO₄ is the phase transformation between its hydrates and polymorphs, particularly at elevated temperatures (above 100° C.), which results in a significant reduction of its solubility limits. Furthermore, the solubility of CaSO₄ is strongly affected by the presence and concentrations of other ions in the system. Another challenge with CaSO₄ scale deposits is that they form even at low pH and can be removed effectively only by mechanical means, which significantly increases the operating cost of the plant.

Current solutions for scale mitigation involve chemical additives that can either shift the scale equilibrium conditions or act as inhibitors by increasing scale formation time. These solutions are typically expensive, environmentally unfriendly, and, in most cases, far from adequate. Hence, to achieve further advances in economics and efficiency of various processes, innovative technologies and groundbreaking ideas for scale mitigation and control must be developed.

There is a need for methods and devices for preventing or inhibiting the formation of scale in numerous industrial processes.

### SUMMARY OF THE INVENTION

This invention relates generally to articles, devices, and methods for inhibiting or preventing the formation of scale during various industrial processes. In certain embodiments, a vessel is provided for use in an industrial process, the vessel including a surface in contact with a mineral solution, wherein the surface is provided or is modified to have γ^{polar}/γ^{total} no greater than about 0.2 and/or the surface is provided or is modified to have a surface energy γ no greater than about 32 mJ/m², thereby providing resistance to mineral scale deposits thereupon.

In one aspect, the invention relates to a vessel for use in an industrial process, the vessel including a surface in contact with a solution, wherein the solution includes at least one mineral and the surface has γ no greater than about 32 mJ/m², thereby providing resistance to mineral scale deposits thereupon. In certain embodiments, the surface has γ no greater than about 25 mJ/m². In certain embodiments, the surface has γ^{polar}/γ^{total} no greater than about 0.125. In certain embodiments, the surface has γ^{polar}/γ^{total} no greater than about 0.05. In certain embodiments, the surface is a scale-phobic surface that inhibits scale formation thereupon. In certain embodiments, the surface includes a fluoropolymer. In certain embodiments, the fluoropolymer is a silsesquioxane. In certain embodiments, the fluoropolymer is fluorodecyl polyhedral oligomeric silsesquioxane. In certain embodiments, the fluoropolymer is a member selected from the group consisting of tetrafluoroethylene (ETFE), fluorinated ethylene-propylene copolymer (FEP), polyvinylidene fluoride (PVDF), perfluoroalkoxy-tetrafluoroethylene copolymer (PFA), polytetrafluoroethylene (PTFE), tetrafluoroethylene perfluoromethylvinylether copolymer (MFA), ethylene-chlorotrifluoroethylene copolymer (ECTFE), ethylene-tetrafluoroethylene copolymer (ETFE), perfluoropolyether, and Tecnoflon.

In certain embodiments, the surface is a coating. In certain embodiments, the surface includes a silane coating. In certain embodiments, the silane coating is a member selected from the group consisting of methylsilane, phenylsilane, isobutylsilane, dimethylsilane, tetramethyldisilane, hexylsilane, octadecylsilane, and fluorosilane.

In certain embodiments, the surface is located on an interior wall of a heat exchanger.

In certain embodiments, the mineral scale deposits include at least one of calcium sulfate, calcium carbonate, barium sulfate, silica, and/or iron.

In certain embodiments, the surface includes discrete nucleation sites thereupon, thereby promoting preferred mineral scale nucleation at the discrete nucleation sites, a resulting defective interface at the surface, and reduced mineral scale adhesion upon the surface.

In certain embodiments, the surface has heterogeneous surface chemistry. In certain embodiments, the surface is patterned with discrete hydrophobic regions and discrete hydrophilic regions. In certain embodiments, the surface is textured. In certain embodiments, the surface includes micro-scale and/or nano-scale particles deposited thereupon. In certain embodiments, the surface includes sintered silica and/or porous anodized aluminum. In certain embodiments, the surface includes micro-scale and/or nano-scale posts. In certain embodiments, the surface includes silicon posts. In certain embodiments, the posts have hydrophobic surfaces. In certain embodiments, the posts have walls that are hydrophobic and tops that are hydrophilic, thereby promoting preferred mineral scale nucleation at the tops and resulting in air pockets between posts.

In certain embodiments, the surface has γ^{polar}/γ^{total} no greater than about 0.15. In certain embodiments, the surface has γ^{polar}/γ^{total} no greater than about 0.10. In certain embodiments, the surface has γ no greater than about 20 mJ/m². In certain embodiments, the surface has γ no greater than about 15 mJ/m². In certain embodiments, the surface has γ no greater than about 10 mJ/m².

In certain embodiments, the vessel is a conduit or receptacle (e.g., pipeline) used in deep sea oil and/or gas recovery. In certain embodiments, the vessel is a conduit or receptacle of a heat exchanger. The description of elements of the embodiments above can be applied to this aspect of the invention as well.

In another aspect, the invention relates to a method of retrofitting a vessel for improved resistance to mineral scale deposits, the method including applying a coating to produce a surface having γ^{polar}/γ^{total} no greater than about 0.2, thereby providing resistance to mineral scale deposits thereupon. In certain embodiments, the surface has γ^{polar}/γ^{total} no greater than about 0.125 or 0.05. The description of elements of the embodiments above can be applied to this aspect of the invention as well.

In another aspect, the invention relates to a method of retrofitting a vessel for improved resistance to mineral scale deposits, the method including applying a coating to produce a surface having γ no greater than about 32 mJ/m², thereby providing resistance to mineral scale deposits thereupon. In certain embodiments, the surface has γ no greater than about 25 mJ/m², 20 mJ/m², 15 mJ/m², or 10 mJ/m². In certain embodiments, the vessel is a conduit or receptacle (e.g., pipeline) used in deep sea oil and/or gas recovery. In certain embodiments, the vessel is a conduit or receptacle of a heat exchanger. The description of elements of the embodiments above can be applied to this aspect of the invention as well.

In another aspect, the invention relates to a method for preparing a surface to provide improved resistance to formation of mineral scale deposits thereupon, the method including the steps of forming a surface and determining that the surface has γ^{polar}/γ^{total} no greater than about 0.2 and/or has γ^{total} no greater than about 32 mJ/m², thereby providing improved resistance to formation of mineral scale deposits thereupon. In certain embodiments, the surface has γ^{polar}/γ^{total} no greater than about 0.125 or 0.05. In certain embodiments, the surface has γ no greater than about 25 mJ/m², 20 mJ/m², 15 mJ/m², or 10 mJ/m². The description of elements of the embodiments above can be applied to this aspect of the invention as well.

In another aspect, the invention relates to a method for preparing a surface to provide improved resistance to formation of mineral scale deposits thereupon, the method including the step of determining γ^{polar} and γ^{total} of the surface and adjusting the surface such that γ^{polar}/γ^{total} greater than about 0.2. In certain embodiments, γ^{polar}/γ^{total} is no greater than about 0.125 or 0.05. In certain embodiments, the method further includes the step of adjusting the surface such that γ^{total} is no greater than about 32 mJ/m². In certain embodiments, γ is no greater than about 25 mJ/m², 20 mJ/m², 15 mJ/m², or 10 mJ/m². In certain embodiments, adjusting the surface comprises recoating or replacing the surface. In certain embodiments, the surface is a surface of a conduit or receptacle (e.g., pipeline) used in deep sea oil and/or gas recovery. In certain embodiments, wherein the surface is a surface of a conduit or receptacle of a heat exchanger. The description of elements of the embodiments above can be applied to this aspect of the invention as well.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1a is a graph of measured contact angles for three separate liquids on various solid surfaces, according to illustrative embodiments of the invention.

FIG. 1b is a graph of surface energy for various solid surfaces, calculated from the contact angles of FIG. 1a, according to illustrative embodiments of the invention.

FIG. 2 includes photographs of an experimental setup used in Example 1 and a chart or matrix of experimental conditions, according to an illustrative embodiment of the invention.

FIG. 3 includes results from an experiment conducted to measure mineral scale formation, according to an illustrative embodiment of the invention.

FIG. 4 includes photographs of an experimental setup used in Example 2, and a matrix of experimental conditions and concentration of CaSO₄, according to illustrative embodiments of the invention.

FIG. 5 includes photographs showing scale formation on exemplary substrates with various surface free energies, according to illustrative embodiments of the invention.

FIG. 6 includes photographs and a graph showing weight gain of various substrates due to scale deposition as a function of total surface free energy, according to illustrative embodiments of the invention.

FIG. 7 includes a series of photographs demonstrating kinetics of scale formation as a function of surface free energy, according to illustrative embodiments of the invention.

FIG. 8 is a graph demonstrating weight gain of various substrates due to scale deposition as a function of polar and apolar components of surface free energy, according to illustrative embodiments of the invention.

FIG. 9 is a schematic of fabrication process of modifying a glass substrate with SAMs of organosilanes including alkylchlorosilanes and alkylalkoxysilanes, according to an illustrative embodiment of the invention.

FIG. 10 are graphs demonstrating reduction in weight gain versus surface free energy, and a plot of reduction in weight gain versus the contribution of polar attractions in the total energy of the surface (i.e. γ^{polar}/γ^{total}), according to an illustrative embodiment of the invention.

### DETAILED DESCRIPTION

It is contemplated that compositions, mixtures, systems, devices, methods, and processes of the claimed invention encompass variations and adaptations developed using information from the embodiments described herein. Adaptation and/or modification of the compositions, mixtures, systems, devices, methods, and processes described herein may be performed by those of ordinary skill in the relevant art.

Throughout the description, where articles, devices and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

Similarly, where articles, devices, mixtures, and compositions are described as having, including, or comprising specific compounds and/or materials, it is contemplated that, additionally, there are articles, devices, mixtures, and compositions of the present invention that consist essentially of, or consist of, the recited compounds and/or materials.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

The use of hydrate-phobic surfaces for reducing hydrate adhesion is described in U.S. patent application Ser. No. 13/218,095, titled “Articles and Methods for Reducing Hydrate Adhesion,” and published as U.S. Patent Application Publication No. 2012/0160362, the text of which is hereby incorporated by reference herein in its entirety.

Described herein are experiments with organosilane-coated substrates with varying surface energies for which a systematic demonstration of the effect of surface energy on scale formation is performed. Scale formation is qualitatively (using SEM) and quantitatively (weight gain) observed at various residence times, in contact with a mineral solution. In one experiment, it is shown that an 85% reduction in weight gain due to scale formation can be achieved by decreasing surface free energy from 51 mJ/m² (bare glass) to 10 mJ/m² (fluorosilane-coated glass). Also discovered is the importance of the polar component of surface free energy as a factor controlling scale formation on a substrate. Application of this discovery is described herein, with respect to selection, modification, measurement, and/or monitoring of surfaces of vessels having prescribed levels of total surface free energy and/or ratios of γ^{polar}/γ^{total}.

It is believed that clusters of salt molecules that are gathered together under random thermal motion must reach a critical size to sustain growth. The free energy barrier (ΔG) of the heterogeneous nucleation of a scale embryo of critical size on a smooth surface, and the corresponding nucleation rate (J) can be expressed as:

$$Δ G = \frac{{πσ}_{substrate - solution} {r}^{* 2}}{3} ( 2 - 3 m + {m}^{3} ) ; \\ J = {J}_{0} exp ( - \frac{Δ G}{kT} ) \qquad ( 1 )$$

where σ_{substrate-solution} is the substrate surface energy, r* is the critical radius of scale nuclei, k is the Bolzmann constant, and J₀ is a kinetic constant. The parameter m is the ratio of the interfacial energies given by m=(σ_{subs,solution}-Γ_{subs,salt}/σ_{salt,solution} where σ_{subs,salt} and σ_{salt,solution} are the substrate-salt and salt-solution interfacial energies, respectively.

Without wishing to be bound by a particular theory, from Eq. (1), the nucleation of scale crystals on a substrate appears to be governed by the surface energy of the substrate. It is experimentally demonstrated herein that decreasing surface free energy decreases scale formation.

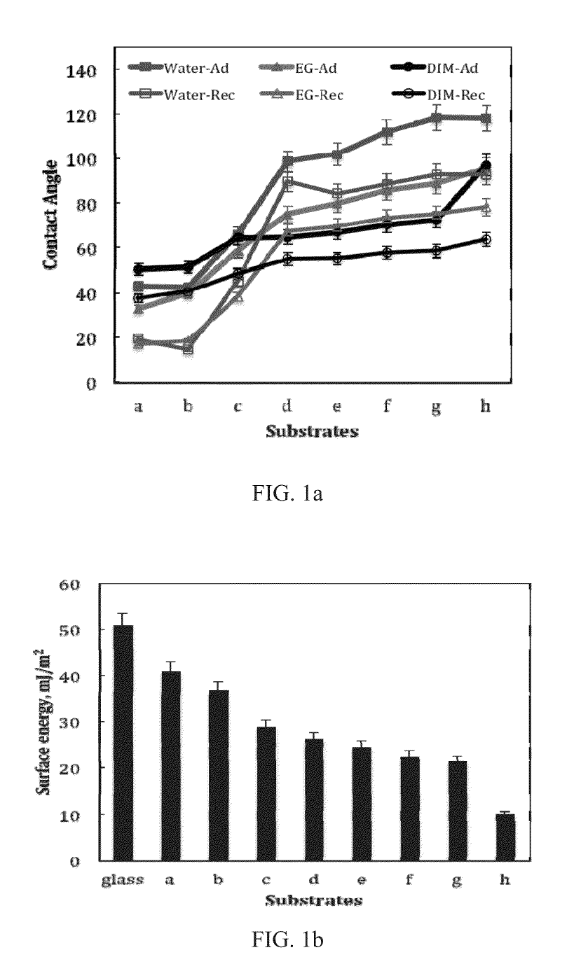

In accordance with certain embodiments, it is presently discovered that scale formation may be reduced by as much as about 85% by reducing the surface energy of the underlying solid surface. In one experiment, a range of solid surfaces with different surface energies was created by depositing several self-assembling organic silane coatings, with surface energies varying between 10 and 41 mJ/m², onto the surfaces of glass substrates. Bare glass surfaces, with a surface energy of 51 mJ/m², were tested along with the coated surfaces, as a control measure. To quantify surface energies, advancing and receding contact angles of three liquids, including one non-polar liquid (di-iodo-methane, DIM) and two polar liquids (water and ethylene glycol, EG), on all substrates, were measured using a ramé-hart goniometer (500-Fl). Surface energies were calculated using the Van Oss-Chaudhury-Good theory. FIG. 1a shows the measured contact angles of the three liquids (water, ethylene glycol, and DIM). FIG. 1b shows the calculated surface energies for the respective surfaces. In these figures, the letters a through h refer to silane coatings, as follows: a=Methylsilane; b=Phenylsilane; c=Isobutylsilane; d=Dimethylsilane; e=Tetramethyldisilane; f=Hexylsilane; g=Octadecylsilane; and h=Fluorosilane.

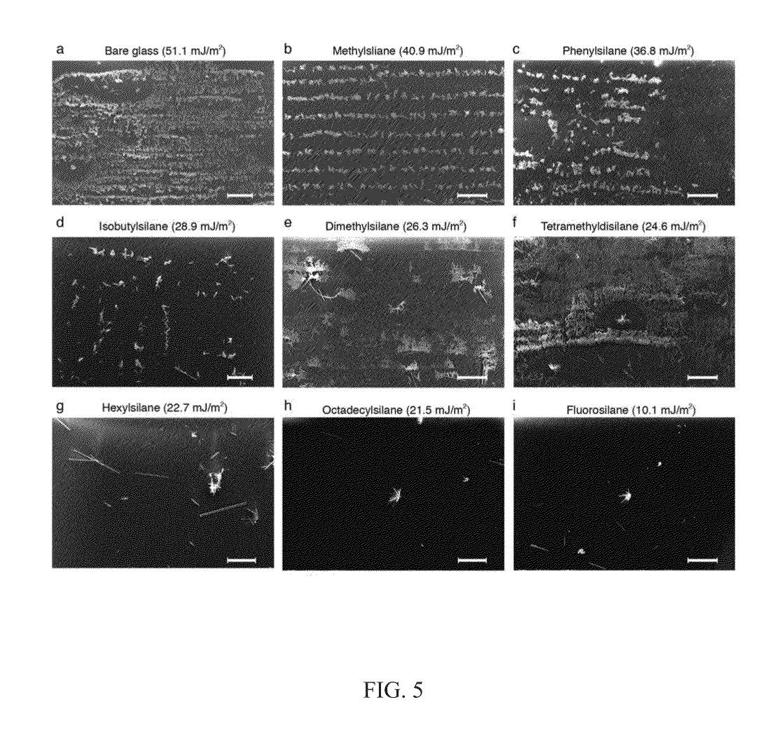

FIG. 5 includes photographs of scale formation on various substrates with different surface energies. The results shows that scale formation becomes more discrete with decreasing surface energy, and details are described in the Experiments below.

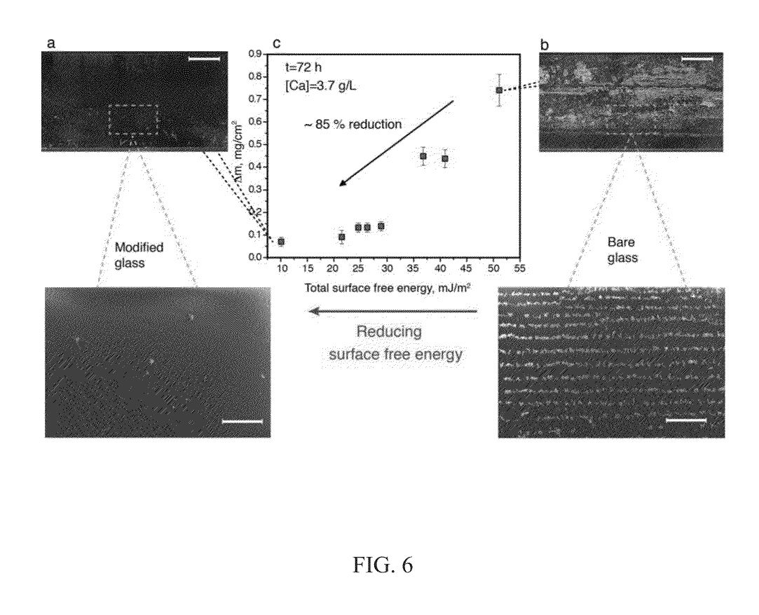

Weight gain on substrates due to scale formation can be characterized by comparing the substrates' weights before and after the experiment. For example, ˜85% reduction was observed in the weight gain of a substrate coated with fluorosilane (FIG. 6 a) with the lowest surface energy among test substrates, compared to that of a bare glass (FIG. 6b), as shown in FIG. 6c.

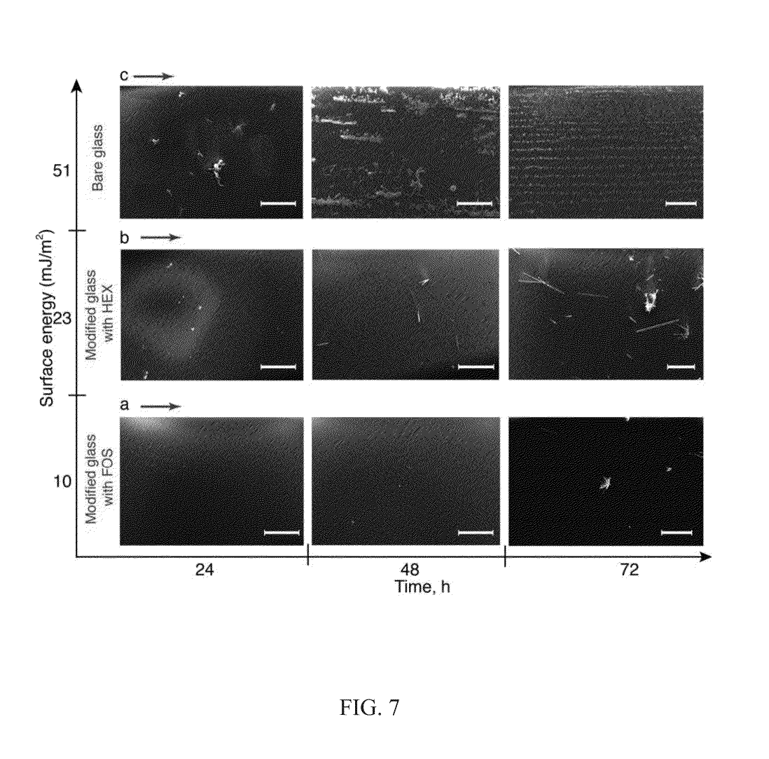

In addition to thermodynamic aspects of surface energy effects on scale formation, the scale growth is demonstrated on three substrates with surface energies ranging from the lowest (fluorosilane coated) to intermediate (hexylsilane coated) to the highest (bare glass). FIG. 7 shows the scanning electron micrographs of test substrates after various residence times ranging from 24 h to 72 h. Consistent with the results in FIG. 5, higher nucleation density (the number of crystals formed per unit area) are observed on bare glass at each of the three times. Bare glass has the highest surface energy and it is believed that the energy barrier for scale nucleation is the least on this substrate. As the surface energy decreases from bare glass to hexylsilane coated- and fluorosilane coated-surfaces, nucleation density decreases, but their size increases. Without wishing to be bound by any particular theory, such behavior is consistent with the nucleation and growth theory that the energy barrier (ΔG) for crystal growth after the nuclei is formed is less than the energy barrier for the nucleation of a new salt nucleus on a substrate with low surface energy.

An important breakdown of surface interactions in terms of polar and apolar terms has been identified herein that further correlates the effect of surface energy and surface polarity on scale formation. Polar interactions are believed to exist due to the Lewis acid and Lewis base sites at the surface that can chemically bond with scale nuclei. Apolar interactions, however, appear to be roughly in the form of London dispersion forces and depend on the polarizability (a) and ionization energy (I) of the molecules involved; these interactions may be referred to as Lifshitz-van der Waals interactions. The polar and apolar components of surface energy may be quantified using the acid-base theory of contact angles (van Oss-Chaudhury-Good approach):

γ_{l,i}(1+cos θᵢ)=2(\sqrt{γₛ^{LW}γ_{l,i}^{LW}}+\sqrt{γₛ⁺γ_{l,i}⁻}+\sqrt{γₛ⁻γ_{l,i}⁺}) (2)

where θᵢ is the measured contact angle of liquid i on solid s, γ^{LW}, γ⁺, and γ⁻ are the Lifshitz-van der Waals (apolar) and the polar components due to the Lewis acid and Lewis base sites, respectively. For reference probe liquids, the values of γ^{LW}, γ⁺, and γ⁻ have been reported previously in Good, R. J. J. Adhes. Sci. Technol. 6, 1269-1302 (1992), the relevant contents of which are incorporated herein by reference. Hence, Eq. (2) provides three components of the surface free energy for any solid. Therefore, determination of these values may be performed by simultaneous solving of the equation for three different liquids.

For example, the contact angles of three probe liquids (water, ethylene glycol, and diiodomethane) can be measured to determine the values of γₛ^{LW}, γₛ⁺, and γₛ⁻ for all the substrates. The polar component of the surface free energy (γₛ^{AB}) can then be calculated using Eq. (3):

γₛ^{AB}=2\sqrt{γₛ⁺}\sqrt{γₛ⁻} (3)

where the superscript AB refers to acid-base (polar) interactions.

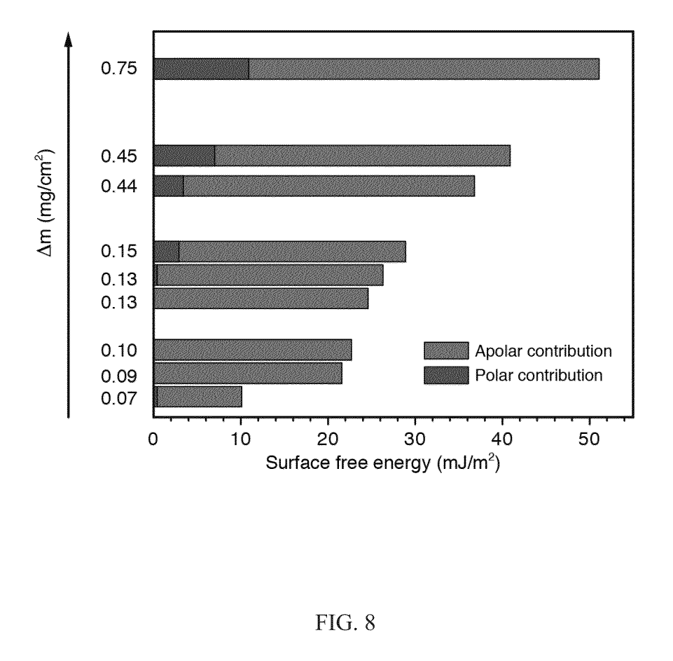

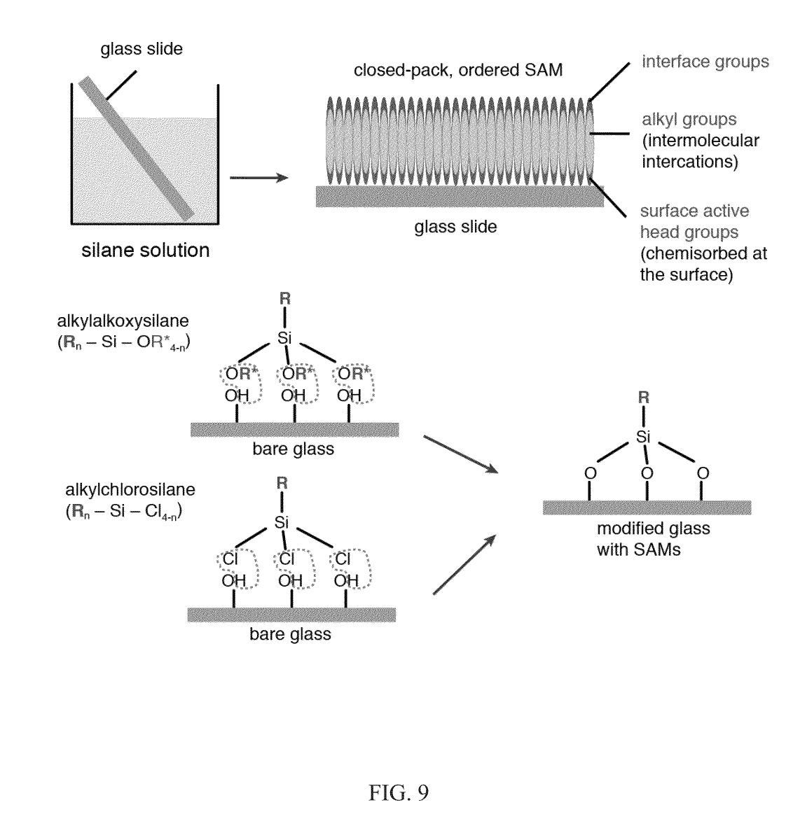

Examples of measured contact angles and calculated surface free energy (γ^{total}) and its components (γ^{LW} and γ^{AB}) are reported in Table 1. FIG. 8 shows substrates' weight gain due to scale formation as a function of surface free energy and the polar/apolar terms. Results indicate that the polar term of the surface free energy is a controlling factor in scale formation on a substrate. Indeed, we observe that when the polar component is less than 5 mJ/m², the substrate weight gain due to scaling is insignificant.

TABLE 1
Measured Contact Angles of three Liquids and calculated surface free
energy and its components (apolar, polar) on test substrates.

| | Contact angles (°) | | | | | | Surface free energy | | |
|---|---|---|---|---|---|---|---|---|---|
| | | | Ethylene glycol | | Diiodomethane | | (mJ/m²) | | |
| | DI water | | (EG) | | (DIM) | | Total | Apolar | Polar |
| Substrate | θ_{adv} | θ_{rec} | θ_{adv} | θ_{rec} | θ_{adv} | θ_{rec} | γ^{total} | γ^{LW} | γ^{AB} |
| Trichloro (1H,1H,2H,2H- | 118.3 ± 4 | 92.8 ± 3 | 95.5 ± 2 | 78.1 ± 2 | 97.0 ± 4 | 63.6 ± 4 | 10.1 | 9.8 | 0.3 |
| perfluorooctyl) silane | | | | | | | | | |
| Octadecyltrichlorosilane | 118.5 ± 3 | 92.9 ± 2 | 88.7 ± 3 | 74.9 ± 3 | 72.3 ± 3 | 58.5 ± 3 | 21.5 | 21.5 | 0.0 |
| Hexylsilane | 112.1 ± 2 | 88.6 ± 4 | 85.6 ± 2 | 73.2 ± 2 | 70.3 ± 3 | 57.8 ± 3 | 22.7 | 22.7 | 0.0 |
| Tetramethyldisilane | 101.9 ± 4 | 84.3 ± 3 | 79.8 ± 4 | 69.3 ± 2 | 66.9 ± 2 | 55.1 ± 3 | 24.6 | 24.6 | 0.0 |
| Dimethylsilane | 98.6 ± 4 | 89.7 ± 2 | 74.9 ± 3 | 67.2 ± 3 | 64.6 ± 3 | 54.9 ± 2 | 26.3 | 25.9 | 0.4 |
| Isobutylsilane | 65.8 ± 3 | 45.3 ± 2 | 58.4 ± 2 | 38.4 ± 4 | 64.4 ± 3 | 48.6 ± 3 | 28.9 | 26.0 | 2.9 |
| Phenylsilane | 42.5 ± 3 | 14.8 ± 3 | 39.9 ± 3 | 18.5 ± 4 | 51.5 ± 3 | 40.8 ± 3 | 36.8 | 33.4 | 3.4 |
| Methylsliane | 43.0 ± 4 | 19.3 ± 2 | 33.1 ± 2 | 17.2 ± 3 | 50.6 ± 2 | 37.8 ± 2 | 40.9 | 33.9 | 7.0 |
| Bare Glass | — | — | — | — | — | — | 51.1 | 40.2 | 10.9 |

In certain embodiments, an apparatus or device (e.g., a vessel, such as a conduit, receptacle, pipeline, or the like) is provided that reduces or prevents the formation of mineral scale. The mineral scale may include, for example, calcium sulfate, calcium carbonate, barium sulfate, silica, iron, and/or other deposits. In certain embodiments, the device reduces or prevents the formation of mineral scale by having a surface with a low surface energy, said surface having exposure to a mineral solution. For example, the surface energy may be no greater than 32 mJ/m², no greater than 25 mJ/m², no greater than 20 mJ/m², no greater than 15 mJ/m², or no greater than 10 mJ/m². In certain embodiments, the surface has a contribution of polar attractions γ^{polar} in the total energy γ^{total} of the surface (i.e., the ratio γ^{polar}/γ^{total}) of no greater than 0.2, no greater than 0.15, no greater than 0.12, no greater than 0.1, no greater than 0.05, or no greater than 0.01. In certain embodiments, γ^{polar}/γ^{total} is in a range of 0.2 to 0.01, or 0.15 to 0.1.

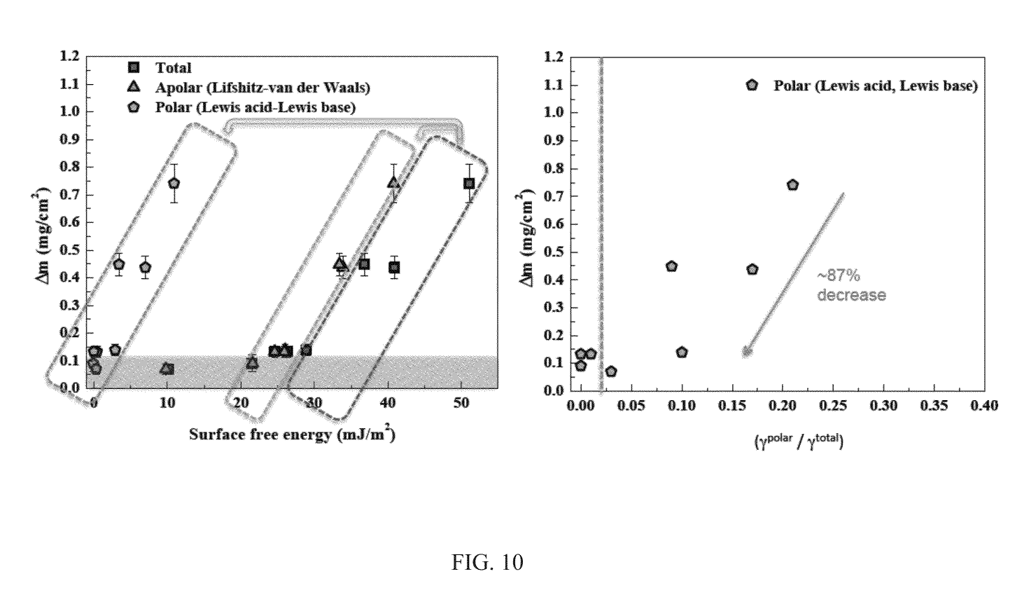

Polar attractions γ^{polar} are believed to exist due to Lewis acid-Lewis base interactions, which are usually in the form of hydrogen bonds. Non-polar interactions are believed to be in the form of London dispersion forces and depend on the polarizability (α) and ionization energy (I) of the molecules involved; these interactions are referred to as Lifshitz-van der Waals interactions. Referring to FIG. 10, in certain embodiments, γ^{polar}/γ^{total} is less than 10 percent. Weight gain became insignificant where the polar term of surface energy is less than 5 mJ/m².

In certain embodiments, a method of retrofitting a device (e.g., a vessel) is provided for improved resistance to scale formation. The method includes depositing a coating (e.g., self-assembling organic silane coating) onto a surface of the device. The coating reduces a surface energy within the device to no greater than 32 mJ/m². In further embodiments, the coating reduces the surface energy to no greater than 25 mJ/m², no greater than 20 mJ/m², no greater than 15 mJ/m², or no greater than 10 mJ/m². In certain embodiments, the coating provides a surface having γ^{polar/γ}^{total} of no greater than 0.2, no greater than 0.15, no greater than 0.12, no greater than 0.1, no greater than 0.05, or no greater than 0.01. In certain embodiments, γ^{polar}/γ^{total} is in a range of 0.2 to 0.01, or 0.15 to 0.1.

In certain embodiments, a scale-phobic surface is provided for minimizing or preventing the formation of scale. The scale-phobic surface may include, for example, a silane coating, such as methylsilane, phenylsilane, isobutylsilane, dimethylsilane, tetramethyldisilane, hexylsilane, octadecylsilane, and/or fluorosilane. In certain embodiments, the scale-phobic surface includes a fluoropolymer. The fluoropolymer may be, for example, a silsesquioxane, such as fluorodecyl polyhedral oligomeric silsesquioxane. In certain embodiments, the fluoropolymer includes tetrafluoroethylene (ETFE), fluorinated ethylene-propylene copolymer (FEP), polyvinylidene fluoride (PVDF), perfluoroalkoxy-tetrafluoroethylene copolymer (PFA), polytetrafluoroethylene (PTFE), tetrafluoroethylene perfluoromethylvinylether copolymer (MFA), ethylene-chlorotrifluoroethylene copolymer (ECTFE), ethylene-tetrafluoroethylene copolymer (ETFE), perfluoropolyether, and/or Tecnoflon.

In some embodiments, the invention relates to an article for use in industrial operation or research set-ups, the article having a surface with lowered surface energy. In certain embodiments, the article is a pipeline (or a part or coating thereof), and the surface is configured to inhibit scale formation thereupon. In certain embodiments, the article is a heat exchanger part or an oil or gas pipeline (or a part or coating thereof), and the surface is configured to inhibit scale formation thereupon.

### EXPERIMENTS

### Example 1

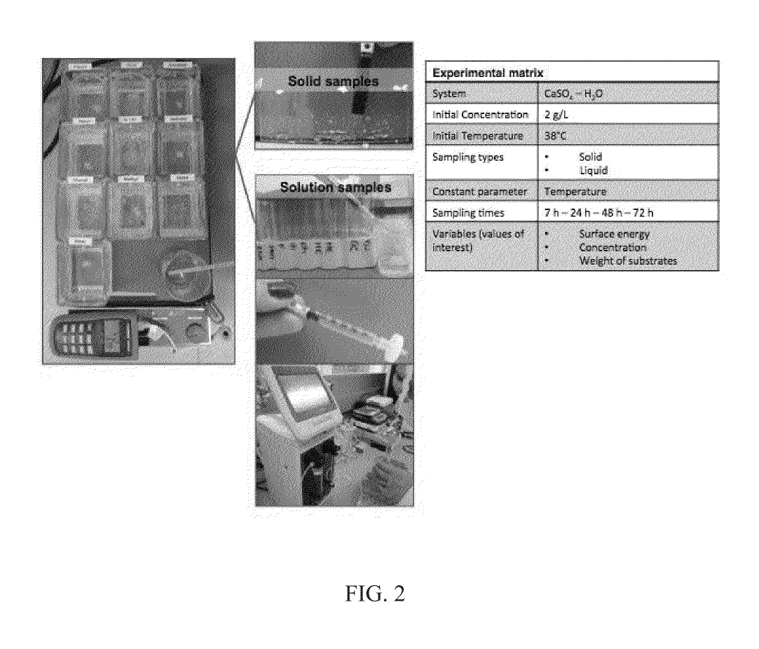

To test the affect of surface energy of the modified substrates on scale formation, a saturated solution of CaSO₄ in water was prepared by dissolving reagent grade chemicals directly without further purification. Batches of four identical coated substrates were placed in a rectangular dish using a holder tray, and the dish was filled with 200 mL of the saturated solution. All dishes (10 batches in this experiment) were then placed on a 15-position hotplate to keep the temperature similar within the holders. The temperature of the solution in all holders was monitored during the term of the experiment, and the measured values were consistent to within ±3° C. FIG. 2 includes photographs of the experimental setup, in accordance with one embodiment of the invention. A chart or matrix of experimental conditions is provided in this figure.

At each sampling round, both solution and substrate samples were taken. Solution samples were withdrawn using a 2 mL syringe, and filtration was performed using 0.22 μm Nylon syringe filters. Withdrawn samples were then diluted by 2 wt. % HNO₃ and stored in sealed plastic test tubes at room temperature. The calcium concentration was determined by Inductively Coupled Plasma (ICP-OES) analysis.

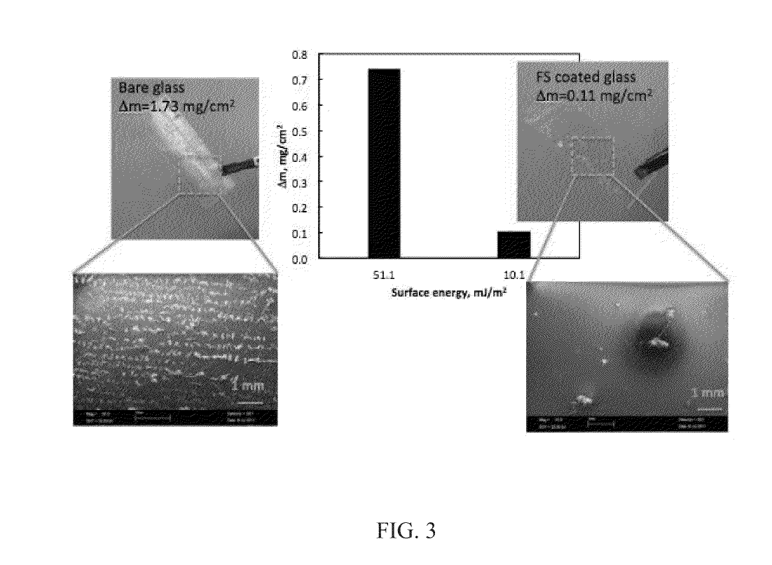

The substrate samples taken from each batch were dried and weight gain due to CaSO₄ solid deposits was calculated by comparing the weight of each sample from before and after the experiment. FIG. 3 shows the results for two substrates after a 72 hour retention time. One of the substrates was bare glass (surface energy γ=51 mJ/m²), the other substrate was glass coated with fluorosilane (surface energy γ=10 mJ/m²). The results show a reduction of about 85% in the amount of solid deposited on the surface, between the bare glass and the fluorosilane-coated surface. SEM images in FIG. 3 of the scale formed on these substrates show more nucleation sites on the bare glass surface than on the fluorosilane-coated surface. The solid clusters formed on the fluorosilane-coated glass were also larger than those formed on the glass surface. While not wishing to be bound by a particular theory, this is likely because the energy barrier of the crystal growth after the nuclei are formed is lower than that of the nucleation process on the fluorosilane coated surface.

To further investigate the affect of surface energy on scale nucleation and adhesion, the breakdown of surface interactions in terms of polar and non-polar attractions was investigated. Polar attractions exist due to the Lewis acid-Lewis base interactions, which are usually in the form of hydrogen bonds. Non-polar interactions are basically in the form of London dispersion forces and depend on the polarizability (a) and ionization energy (I) of the molecules involved. These interactions are referred to as Lifshitz-van der Waals interactions.

The results showed that significant reduction in scale deposition may be achieved if the contribution of polar attractions in the total energy of the surface (i.e., γ^{polar}/γ^{total}) is below 10%. The results of this work provide guidelines to design new surfaces with improved scale formation properties by manipulating the surface chemistry and morphology. Such ability to control and mitigate scale formation not only reduces costs of chemical and thermal treatment for scale inhibition and removal, but it also has implications for efficiency and lifetime enhancement and process reliability improvement in various industrial processes.

### Example 2

In this Example, a catalogue of smooth substrates comprising functionalized coatings with surface free energies ranging between 10 and 50 mJ/m², by depositing self-assembled monolayers of organosilanes on glass substrates. Their surface energy by measuring contact angles of three probe fluids (water, ethylene glycol, diiodomethane) and quantifying the polar and apolar components of surface free energy using the van Oss-Good-Chaudhury approach.

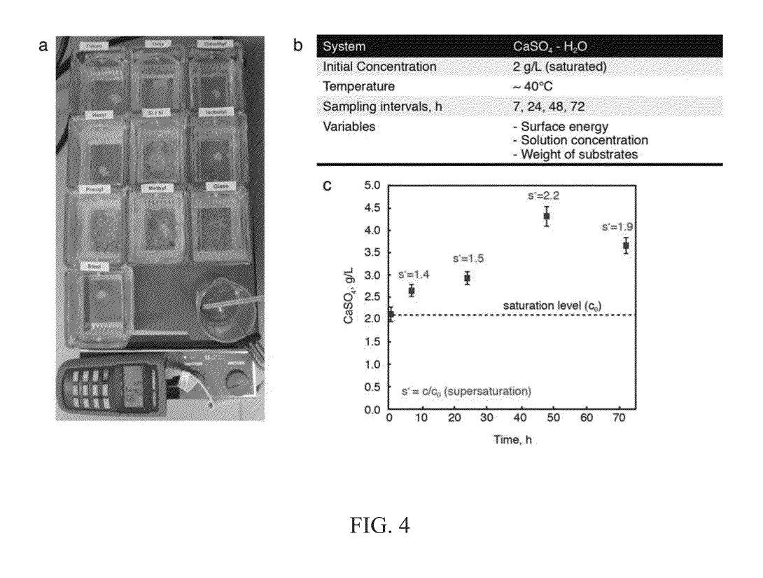

To systematically study the effect of surface free energy on scale formation, the modified surfaces were exposed to a saturated solution of calcium sulfate in water for up to three days. The experimental set-up and matrix summarizing test conditions are shown in FIG. 4a,b. Both solution and substrate samples were withdrawn at four time intervals. Super-saturation of the system was determined by measuring calcium concentration in solution samples using Inductively Coupled Plasma (ICP-OES) (FIG. 4c).

The formation of organic silane-based self-assembled monolayers (SAMs) on silicon oxide surface and glass surface provides an opportunity to introduce chemically well-defined thin films at the molecular scale.

SAMs of alkylchlorosilanes (Rₙ—Si—Cl₄₋ₙ) and alkylalkoxysilanes (Rₙ—Si—(OR′)₄₋ₙ) (see Table 2) are fabricated. These silanes require hydroxylated surfaces as the substrate for their formation. The driving force for this self-assembly is the in situ formation of polysiloxane, which is connected to surface silanol groups (—SiOH) via Si—O—Si bonds. We conformed the complete surface reaction of the —SiCl3 groups using X-ray photoelectron spectroscopy (XPS).

SAMs of alkylchlorosilanes, with Rₙ—Si—Cl₄₋ₙ precursor, were fabricated using a solution of 0.1 vol % silane in toluene; 0.6 vol % water was added to the solution to promote the reaction. Glass slides (from vwr, microscope slides, 75×25×1 mm in dimensions) were immersed in the solution and sonicated for 2 min. After the reaction was completed, modified substrates were cleaned by sonication in acetone for 2 min and dried them using N₂ gas (Air gas, NI300).

Silane SAMs of alkylalkoxysilanes with by Rₙ—Si—(OR′)₄₋ₙ were fabricated in an acidic environment to promote the reaction. Glass slides were immersed in a 0.2 vol % silane in ethanol under sonication for 2 min. Hydrochloric acid (from Mallinckrodt, ACS grade) was added to the solution to decrease the solution pH to 2 (˜0.075 vol %). After sonication, glass slides were left in the slime solution for 24 h. They were then washed with water and dried with N₂ gas (Air gas, NI300).

TABLE 2
Various alkylchlorosilanes and alkylalkoxysilanes that were used to fabricate SAMs on glass slides.

| | | | Sigma Aldrich |
|---|---|---|---|
| Silane | Linear formula | Chemistry | grade |
| Trichloro(1H,1H,2H,2H- perfluorooctyl)silane | CF₃(CF₂)₅CH₂CH₂SiCl₃ | 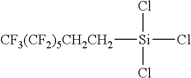 | 97% |
| Trichloro(octadecyl)silane | CH₃(CH₂)₁₇SiCl₃ | CH₃(CH₂)₁₆CH₂SiCl₃ | ≧90% |
| Trichloro(hexyl)silane | CH₃(CH₂)₅SiCl₃ | 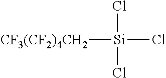 | 97% |
| 1,2-Dichloro-tetramethyl- disilane | [ClSi(CH₃)₂]₂ | 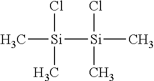 | 95% |
| Dichloro-dimethylsilane | (CH₃)₂SiCl₂ | 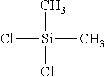 | ≧98.5% |
| Isobutyl(trimethoxy)silane | (CH₃)₂CHCH₂Si(OCH₃)₃ | 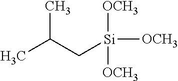 | ≧98% |
| Triethoxy-phenylsilane | C₆H₅Si(OC₂H₅)₃ | 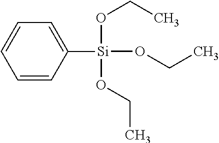 [SMILES: CCO[Si](OCC)(OCC)c1ccccc1] | ≧98.5% |
| Trimethoxy-methylsilane | CH₃Si(OCH₃)₃ | 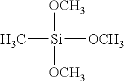 | ≧98% |

FIG. 5 shows scale formation on exemplary substrates with various surface free energies. Values in parenthesis represent the total surface free energy of the substrates: a=bare glass; b=methylsilane; c=phenylsilane; d=isobutylsilane; e=dimethylsilane; f=tetramethyldisilane; g=hexylsilane; h=octadecylsilane; i=fluorosilane. Scale bars are 500 μm for all cases.

FIG. 6 shows exemplary substrates' weight gain due to scale deposition as a function of total surface free energy. FIG. 6a is an actual photograph and SEM image of the substrate modified with fluorosilane coating. FIG. 6b is an photograph and SEM image of a bare glass with a high surface free energy. FIG. 6c shows the reduction in weight gain of the substrates as a function of surface free energy after 72 h. An unusual, significant drop-off in Δm is observed at around 32 mJ/m² surface free energy. Calcium concentration in the system, measured by ICP, was 3.7 g/L. Scale bars on actual photographs and SEM images are 10 mm and 1 mm, respectively.

FIG. 7 demonstrates kinetics of scale formation as a function of surface free energy. FIG. 7a are SEM images of modified substrates with fluorosilane (FOS) with the lowest surface energy among all the substrates at three various sampling intervals (24, 48, and 72 h). FIG. 7b are SEM images of modified substrates with hexylsilane (HEX) with an intermediate surface energy. FIG. 7c are SEM images of bare glass substrates with highest surface free energy among all. Scale bars are 1 mm on all cases.

FIG. 8 demonstrates substrates' weight gain due to scale deposition as a function of polar and apolar components of surface free energy. Weight gain is insignificant when the polar term of the surface energy is below 5 mJ/m² because a surface with such attributes cannot form strong chemical bonds with scale molecules. Therefore, it is less attractive to scale nuclei, thus offers scalephobic properties.

As shown in this Example, a catalogue of organosilane-coated substrates are made with varying surface energies and performed a systematic study of surface energy effect on scale formation. Scale formation on the substrates was characterized qualitatively (using SEM) and quantitatively (weight gain) at various residence times. The results show that 85% reduction in weight gain due scale formation can be achieved by decreasing surface free energy form 51 mJ/m² (bare glass) to 10 mJ/m² (fluorosilane-coated glass). It is believed that the reason behind this behavior is attributed to the nucleation theory that substrates with high surface energy have a lower energy barrier for nucleation.

In addition to thermodynamic aspect, the scale growth over time on substrates with different surface energies was studies. It is found that low surface energy substrates have fewer numbers, but larger, salt crystal deposited on them. Without wishing to be bound by a particular theory, it is believed that this is due to the fact that the energy barrier to grow a salt crystal after it is formed is less than that to form a new salt embryo on the surface. The breakdown of surface free energy was also studies and it was found that the polar component is the key factors that control scale formation on a substrate. This work can be used on developing materials that are resistant to scaling for industrial applications. The results of this work provide guidelines to design scalephobic surfaces by manipulating the surface chemistry and make it less prone to attract scale nuclei. Such ability to control and mitigate scale formation would reduce costs of chemical and thermal treatments for scale inhibition and removal. This also provides new pathways to enhance the reliability, lifetime, and efficiency of various industrial processes.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A vessel for use in an industrial process, the vessel comprising a surface in contact with a solution, wherein the solution comprises at least one mineral and the surface has γpolar/γtotal no greater than about 0.2, thereby providing resistance to mineral scale deposits thereupon.

2. A vessel for use in an industrial process, the vessel comprising a surface in contact with a solution, wherein the solution comprises at least one mineral and the surface has γ no greater than about 32 mJ/m2, thereby providing resistance to mineral scale deposits thereupon.

3. The vessel of claim 1, wherein the surface has γ no greater than about 25 mJ/m2.

4. The vessel of claim 1, wherein the surface has γpolar/γtotal no greater than about 0.125.

5. The vessel of claim 1, wherein the surface has γpolar/γtotal no greater than about 0.05.

6. The vessel of claim 1, wherein the surface is a scale-phobic surface that inhibits scale formation thereupon.

7. The vessel of claim 1, wherein the surface comprises a fluoropolymer.

8. The vessel of claim 7, wherein the fluoropolymer is a silsesquioxane.

9. The vessel of claim 7, wherein the fluoropolymer is fluorodecyl polyhedral oligomeric silsesquioxane.

10. The vessel of claim 7, wherein the fluoropolymer is a member selected from the group consisting of tetrafluoroethylene (ETFE), fluorinated ethylene-propylene copolymer (FEP), polyvinylidene fluoride (PVDF), perfluoroalkoxy-tetrafluoroethylene copolymer (PFA), polytetrafluoroethylene (PTFE), tetrafluoroethylene perfluoromethylvinylether copolymer (MFA), ethylene-chlorotrifluoroethylene copolymer (ECTFE), ethylene-tetrafluoroethylene copolymer (ETFE), perfluoropolyether, and Tecnoflon.

11. The article of claim 1, wherein the surface is a coating.

12. The vessel of claim 1, wherein the surface comprises a silane coating.

13. The vessel of claim 12, wherein the silane coating is a member selected from the group consisting of methylsilane, phenylsilane, isobutylsilane, dimethylsilane, tetramethyldisilane, hexylsilane, octadecylsilane, and fluorosilane.

14. The vessel of claim 1, wherein the surface is located on an interior wall of a heat exchanger.

15. The vessel of claim 1, wherein the mineral scale deposits comprise at least one of calcium sulfate, calcium carbonate, barium sulfate, silica, and/or iron.

16. The vessel of claim 1, wherein the surface comprises discrete nucleation sites thereupon, thereby promoting preferred mineral scale nucleation at the discrete nucleation sites, a resulting defective interface at the surface, and reduced mineral scale adhesion upon the surface.

17. The vessel of claim 1, wherein the surface has heterogeneous surface chemistry.

18. The vessel of claim 17, wherein the surface is patterned with discrete hydrophobic regions and discrete hydrophilic regions.

19. The vessel of claim 1, wherein the surface is textured.

20. The vessel of claim 1, wherein the surface comprises micro-scale and/or nano-scale particles deposited thereupon.

21. The vessel of claim 1, wherein the surface comprises sintered silica and/or porous anodized aluminum.

22. The vessel of claim 1, wherein the surface comprises micro-scale and/or nano-scale posts.

23. The vessel of claim 22, wherein the surface comprises silicon posts.

24. The vessel of claim 22, wherein the posts have hydrophobic surfaces.

25. The vessel of any of claim 22, wherein the posts have walls that are hydrophobic and tops that are hydrophilic, thereby promoting preferred mineral scale nucleation at the tops and resulting in air pockets between posts.

26. The vessel of claim 1, wherein the surface has γpolar/γtotal no greater than about 0.15.

27. The vessel of claim 1, wherein the surface has γpolar/γtotal no greater than about 0.10.

28. The vessel of claim 1, wherein the surface has γ no greater than about 20 mJ/m2.

29. The vessel of claim 1, wherein the surface has γ no greater than about 15 mJ/m2.

30. The vessel of claim 1, wherein the surface has γ no greater than about 10 mJ/m2.

31. The vessel of claim 1, wherein the vessel is a conduit or receptacle used in deep sea oil and/or gas recovery.

32. The vessel of claim 1, wherein the vessel is a conduit or receptacle of a heat exchanger.

33. A method of retrofitting a vessel for improved resistance to mineral scale deposits, the method comprising applying a coating to produce a surface having γpolar/γtotal no greater than about 0.2, thereby providing resistance to mineral scale deposits thereupon.

34. A method of retrofitting a vessel for improved resistance to mineral scale deposits, the method comprising applying a coating to produce a surface having γ no greater than about 32 mJ/m2, thereby providing resistance to mineral scale deposits thereupon.

35. The method of claim 33, wherein the vessel is a conduit or receptacle used in deep sea oil and/or gas recovery.

36. The method of claim 33, wherein the vessel is a conduit or receptacle of a heat exchanger.

37. A method for preparing a surface to provide improved resistance to formation of mineral scale deposits thereupon, the method comprising the steps of forming a surface and determining that the surface has γpolar/γtotal no greater than about 0.2 and/or has γtotal no greater than about 32 mJ/m2, thereby providing improved resistance to formation of mineral scale deposits thereupon.

38. A method for preparing a surface to provide improved resistance to formation of mineral scale deposits thereupon, the method comprising the step of determining γpolar and γtotal of the surface and adjusting the surface such that γpolar/γtotal is no greater than about 0.2.

39. The method of claim 38, further comprising the step of adjusting the surface such that γtotal is no greater than about 32 mJ/m2.

40. The method of claim 38, wherein the step of adjusting the surface such that γpolar/γtotal is no greater than about 0.2 comprises recoating the surface or replacing the surface.

41. The method of any one of claim 37, wherein the surface is a surface of a conduit or receptacle used in deep sea oil and/or gas recovery.

42. The method of any one of claim 37, wherein the surface is a surface of a conduit or receptacle of a heat exchanger.
